(19) United States
(12) Patent Application Publication
(10) Pub. No.: US 2007/0112444 A1
(43) Pub. Date: May 17, 2007

(54) Portable wireless communication device with HUD projector, systems and methods

(76) Inventors: William P. Alberth JR., Prairie Grove, IL (US); Robert A. Zurek, Antioch, IL (US)

Correspondence Address: MOTOROLA INC, 600 NORTH US HIGHWAY 45, ROOM AS437, LIBERTYVILLE, IL, 60048-5343, US

(21) Appl. No.: 11/273,313

(22) Filed: Nov. 14, 2005

(51) Int. Cl. G05B 13/02

(52) U.S. Cl. 700/32

(57) ABSTRACT

A portable communication device (200) including a portable communication device motion information obtaining device (230), for example, a GPS receiver, communicably coupled to a controller, an image projector (260) communicably coupled to the controller, the image projector projecting an image based on information from the portable communication device motion information obtaining device. In one embodiment image is projected onto a partially reflective film for viewing in a head-up (HUD) display application.

### FIELD OF THE DISCLOSURE

The present disclosure relates generally to portable communication devices, and more particularly to portable communication terminals capable of projecting information, for example, using a head-up display (HUD), systems and methods.

### BACKGROUND OF THE DISCLOSURE

Head-up display (HUD) systems are known generally. HUD systems are currently available in some luxury automobile models as a standard feature and as an optional feature in lesser models. In automotive HUD applications, a projector projects visual information onto a partially reflective/partially transparent screen disposed on the vehicle windshield. The projected information is ideally focused an infinite distance from the viewer to reduce eye strain associated with changing focus between near and far objects, as is typical when glancing at dashboard instruments while driving. In automotive applications, it is also known to project navigation information including turn-by-turn directions, as well as vehicle and accessory performance information such as engine speed, audio settings etc. onto a display screen for viewing by the user.

The various aspects, features and advantages of the instant disclosure will become more fully apparent to those having ordinary skill in the art upon careful consideration of the following Detailed Description with the accompanying drawings described below. The drawings may have been simplified for clarity and are not necessarily drawn to scale.

### BRIEF DESCRIPTION OF THE DRAWINGS

FIG. 1 illustrates a portable communication device projecting an image in an automotive application.

FIG. 2 illustrates an exemplary portable communication having an image projector.

FIG. 3 illustrates a portable communication device cradle.

### DETAILED DESCRIPTION

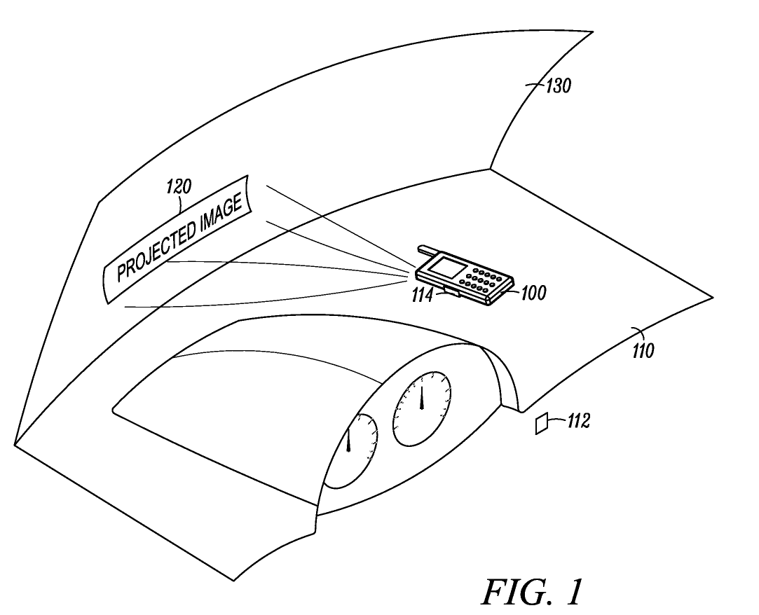

FIG. 1 illustrates a portable communication device 100 mounted on an vehicle dashboard 110 and oriented to project an image onto a semi-reflective film 120 adhered to a windshield 130 of the automobile as discussed more fully below. In other embodiments, the portable communication device projects an image onto other portions of the vehicle. The device 100 may also be used to project an image onto a target other than an automobile, for example, onto a wall or a screen or some other article. Generally, the vehicle may be any terrestrial or airborne vehicle. These and other aspects of the disclosure are discussed below.

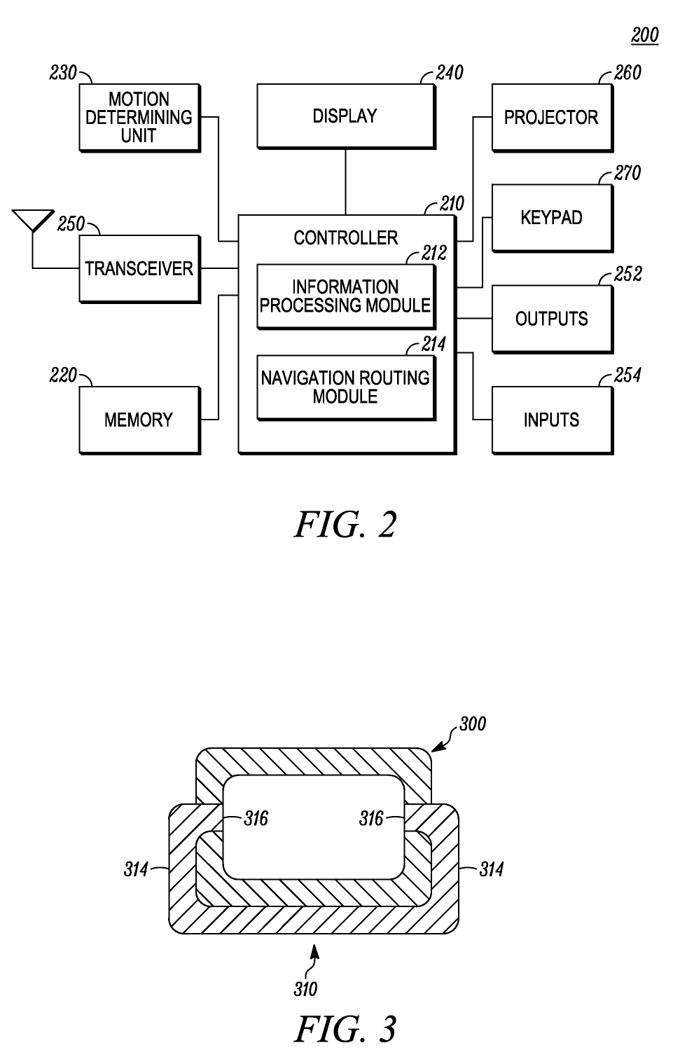

FIG. 2 is an illustrative portable communication device 200 comprising generally a controller 210 communicably coupled to memory 220. The memory may include RAM, ROM, and removable and/or auxiliary memory devices among other forms of memory. In one embodiment, one or more processor executable program(s) enabling functionality discussed below is stored in memory for execution by the controller, for example, a digital processor.

In FIG. 2, the controller 210 is communicably coupled to a motion determining unit 230 capable of determining motion related information of the portable wireless communication device. Exemplary motion related information includes velocity, direction, speed, and current location, etc. In some embodiments, the motion related information for the portable communication device is determined at the device. In one embodiment, the motion determining unit is a satellite positioning system receiver, for example, a NAVSTAR GPS receiver, a GLONASS receiver, or a Galileo receiver, or some other satellite signal receiver capable of determine velocity and/or position of the portable communication device. In another embodiment, the motion determining unit is an inertial navigation device attached to or housed within the portable wireless communication device.

In FIG. 2, the portable communication device includes a wireless transceiver 250 communicably coupled to the controller. In one embodiment, the transceiver is a cellular communication transceiver, although in other embodiments it could be some other type of transceiver, examples of which are discussed below. In some embodiments where the device also includes a satellite signal receiver, the motion information may be computed at the network based on pseudorange and/or other information provided by the portable communication device. In a related embodiment, the motion information computed by the network is communicated to the wireless receiver of the portable communication device, and this information is subsequently used as a basis for projecting an image onto a target that may be perceived by a user, as discussed below.

In another embodiment, the motion determining unit is a wireless transceiver that determines motion related information of the portable communication device based on radio signals communicated with one or more base and/or reference stations in a radio communications network, for example, in a cellular communications network. In another embodiment, the motion determining unit obtains motion information from a source beyond the device, for example, from a wireless communication network. Various schemes are known for determining the location of a radio communication device communication with plural base and/or reference stations, including schemes based on angle of arrival (AOA), enhanced observed time of arrival (EOTD), among others. In these and other terrestrial location schemes, the location of the portable communication device is computed either at the portable device or in network infrastructure entity. Thus, generally, the motion information for the portable communication device may be determined at the device or it may be determined at a remote source and communicated to the device.

In some embodiments, the portable communication device also includes a user interface. In FIG. 2, a video display device 240 and a keypad 270 are coupled to the controller 210. In some embodiments, the device also includes other outputs 252 and inputs 254 coupled to the controller. In cellular handsets, for example, one input may be a microphone and one output may be a headphone and/or stereo audio output jack, among other inputs and outputs. Other exemplary inputs/outputs may be in the form of data ports, etc. as is well known by those having ordinary skill in the art. Some embodiments may also include a short range radio device, for example, a Bluetooth transceiver, or a WIFI or other wireless local area network (WLAN) receiver. One or more of these radio devices may be included alone or in combination with a cellular transceiver. Not all portable communication devices envisaged by the instant disclosure will include all components or features illustrated in FIG. 2.

In FIG. 2, the portable communication device also includes an optical image projector 260 capable of projecting images onto a target capable of being perceived by a user. Particularly, the optical image projector projects images focused a distance away from the portable communication device. In one embodiment, the image projector is a head-up display projector that projects images focused at near infinity onto a partially reflective film. In another embodiment, the image projector projects the image onto an opaque target, wherein the projected image is focused at a distance less than near infinity. The projector could be a digital light processor (DLP) based image projector, or a liquid crystal display (LCD) based image projector, or an image projector based on some other technology. These and other image projectors may alternatively project images onto a screen or some other non-specific target other than a partially reflective film in a head-up display. The projected images may be still and/or video images.

In one application, in FIG. 2, the projector 260 of the portable communication device projects motion-related image information based on information obtained from the motion determining unit 230. The controller 210 includes an information processing module 212 for processing motion relation information obtained from the motion determining unit and for providing the motion related information to the projector 260, which projects image related information based thereon. The motion-related information includes any one or more of velocity, heading, speed, location and altitude information. In FIG. 1, for example, the communication device 100 mounted in the vehicle projects motion related information related to the device onto the partially reflective film 120 on the windshield 130. For embodiments where the communication device 100 is located in the vehicle, any motion information for the device 100 inherently applies to the vehicle. Thus in an embodiment where the motion detecting unit detects the velocity of a portable communication device mounted in a vehicle, the velocity projected onto the vehicle windshield is also that of the vehicle. The exemplary head-up display may project location, velocity and other motion related information pertaining to the portable display device and the vehicle in which the portable device is mounted for observation by the driver.

In another embodiment, the portable communication device projects navigation information related to the motion of the portable communication device, and the vehicle in which the portable communication device is mounted. The navigation information may be in the form of a map identifying where the device, and the vehicle in which the device is mounted, are located. The projected navigation information may also include heading or routing information and/or directions for the vehicle operator or occupants. In FIG. 1, the navigation information is projected onto the windshield for ready viewing by the vehicle operator or by a vehicle navigator. It may also be projected onto some other portion of the vehicle.

In one embodiment, the navigation information is communicated to the portable communication device from a remote location, for example, from a navigation/routing server via a cellular communication network. Alternatively, in FIG. 2, the navigation/routing information may be processed by a navigation/routing module 214 of the controller. In another embodiment, the navigation/routing information is obtained from an auxiliary navigation/routing device via a port at the input 254 or via Bluetooth or other short range radio receiver. The auxiliary navigation device may be located in the vehicle or it may be an accessory. The information processing module 212 processes any navigation information obtained from the navigation routing module or from an external source prior to projecting the information.

In another embodiment, the portable communication device receives information from an external source and then projects an image from the image projector based on the information received from the external source. In FIG. 1, for example, the portable communication device 100 receives vehicle-related information. Some of the vehicle-related information may be of the type that is ordinarily indicated by a dashboard display and/or information that is not otherwise provided to the vehicle operator. Exemplary vehicle-related information includes vehicle speed, engine rpm, mileage, temperature, audio settings, among other vehicle-related information. Projecting such information, focused at infinity or some great distance from the vehicle, onto the windshield renders the information readily visible to the operator.

In one embodiment, in FIG. 1, a transmitter 112 in the vehicle transmits the vehicle-related information for reception by a wireless receiver, for example, a Bluetooth receiver, of the portable wireless communication device. Alternatively, the vehicle-related information is communicated from the vehicle to the portable communication device via a hardwired cable coupled to a data input port of the device. In FIG. 2, the vehicle-related information is processed by the information processing module 212 before being projected by the projector 260.

In another embodiment, the portable communication device receives an incoming call, for example, a voice call or a message, and the projector projects an image associated with the incoming call. For example, the portable communication device may project an image on the windshield indicating the arrival of an incoming call, possibly identifying whether the call is a voice call or a text or voice message. The identity of the caller, either by name or identification of the originating number, may also be projected. In some embodiments, the portable communication device may also project the contents of text messages. Generally, any information capable of being displayed on a display of the portable communication device may be projected by the projector. All such information, however, may not be suitable for projection for viewing by the operator of the vehicle.

In FIG. 1, in another embodiment, the portable communication device 100 is mounted on a cradle 114 fastened to the dashboard 130. The cradle 114 may be fastened to the dashboard by an adhesive tape or by Velcro or by some other means. FIG. 3 is a view of a portable communication device 300 mounted in a cradle 310. The illustrative cradle includes resilient side portions 314 with one or more inwardly protruding tabs 316 that fit into mating recesses on the portable device 300. The side portions 314 flex outwardly as the portable device is disposed therebetween until the tabs seat in the corresponding recesses of the device. The illustrated cradle is merely an exemplary form and is not intended to limit the disclosure as there are many alternative structures by which the device may be mounted. In an alternative embodiment, for example, the portable device could be held in place by mating Velcro strips between the device and the dashboard. The particular mechanism by which the portable device is mounted on the dashboard is not relevant. In embodiments where images are projected onto a partially reflective film, the portable device should be positioned so that the projector projects the image onto the film. In FIG. 1, the cradle orients the portable communication device so that the image is projected substantially horizontally.

In another embodiment, when the portable communication device is mounted on the dashboard, for example, when it is engaged in the cradle 114 in FIG. 1, the portable communication device detects that it is so mounted and activates the image projector. This detection can be done through any known sensing means such as a mechanical switch, a magnetic switch, a RFID tag identified with the RF transceiver, or the like. In FIG. 2, such an input could be provided at inputs 254 of the device. Alternatively, the projector could be actuated upon detecting that the portable communication device is receiving information from the vehicle, for example, when a Bluetooth receiver of the portable device receives information from the automobile to be projected on the windshield.

While the present disclosure and the best modes thereof have been described in a manner establishing possession by the inventors and enabling those of ordinary skill in the art to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable communication device including a motion determining unit and an image projector, the method comprising:
obtaining information related to motion of the portable wireless communication device;
projecting an image from the portable wireless communication device based on the information related to the motion of the portable wireless communication device,
the projected image focused at a distance from the portable communication device.

2. The method of claim 1, obtaining information related to the motion of the portable communication device includes determining the information at the portable communication device.

3. The method of claim 1, projecting the image from the portable communication device includes projecting velocity information related to the motion of the portable communication device.

4. The method of claim 1, projecting the image from the portable communication device includes projecting navigation information related to the motion of the portable communication device.

5. The method of claim 1, projecting the image from the portable communication device includes projecting location information related to the motion of the portable communication device.

6. The method of claim 1, projecting an image from the portable communication device includes projecting an image focused at near infinity based on the information related to the motion of the portable communication device.

7. The method of claim 1, obtaining information related to the motion of the portable communication device includes obtaining information at a wireless receiver of the wireless communication device.

8. The method of claim 1, obtaining information related to motion of the portable communication device using a satellite positioning system receiver of the portable communication device.

9. The method of claim 1, obtaining information related to the motion of the portable communication device from a vehicle.

10. The method of claim 1, activating a projector of the image upon detecting that the portable communication device has been coupled to a cradle.

11. A portable communication device, comprising:
a controller;
a portable communication device motion information obtaining device communicably coupled to the controller;
an image projector communicably coupled to the controller,
the image projector projecting an image based on information from the portable communication device motion information obtaining device,
the projected image focused at a distance from the portable communication device.

12. The device of claim 11,
the portable communication device motion information obtaining device is a satellite positioning system receiver,
the image projector projecting an image based on information provided by the satellite positioning system receiver.

13. The device of claim 11,
the portable communication device motion information obtaining device is a wireless receiver communicably coupled to the controller,
the image projector projecting an image based on information provided by the wireless receiver.

14. The device of claim 13, the portable communication device including a cellular transceiver separate from the wireless receiver.

15. The device of claim 11, the image projector is a head-up display projector projecting an image focused at near infinity.

16. The device of claim 11,
the portable communication device motion information obtaining device is a navigation device,
projecting the image from the portable communication device includes projecting navigation information related to the motion of the portable communication device.

17. The device of claim 11, further comprising a semi-transparent film, the image projector having a projection axis extending through the semi-transparent film.

18. The device of claim 11, a cradle having a mount, the portable communication device coupled to cradle, the mount configured to orient the image projector so that images are projected substantially horizontally.

19. The device of claim 18, a cradle connection detector coupled to the controller, the cradle connection detector detecting when the portable communication device is connected to the cradle.

20. A method in a portable cellular communication device including a non-cellular receiver and a head-up image projector, the method comprising:
receiving information from an external source at the portable wireless communication device;
projecting an image from an image projector based on the information received from the external source.

21. The method of claim 20,
receiving information from the external source includes receiving automotive information,
projecting the image includes projecting an image based on the automotive information.

22. The method of claim 20,
receiving information from the external source includes receiving navigation information,
projecting the image includes projecting an image based on the navigation information.

23. The method of claim 20,
receiving information includes receiving an incoming call at the cellular transceiver,
projecting the image includes projecting information associated with the incoming call.
